(19) United States
(12) Patent Application Publication
(10) Pub. No.: US 2017/0300104 A1
(43) Pub. Date: Oct. 19, 2017

(54) POWER-SAVING METHOD AND AN ELECTRONIC DEVICE FOR PERFORMING POWER CONSUMPTION MANAGEMENT

(71) Applicant: MediaTek Inc., Hsin-Chu (TW)

(72) Inventors: Chun-Wei CHEN, Toufen Township (TW); Jen-Chieh YANG, Hsinchu City (TW)

(21) Appl. No.: 15/130,990

(22) Filed: Apr. 17, 2016

(51) Int. Cl. G06F 1/32

(52) U.S. Cl. CPC G06F 1/3246; G06F 1/3209; G06F 1/3287

(57) ABSTRACT

A power-saving method for performing power consumption management on an electronic device is provided. The power-saving method includes determining whether a software application executed on the electronic device relates to a network service or not; and disabling at least one system-activating event provided by the software application for the electronic device when the software application relates to the network service and when the network service is unavailable to the electronic device.

### BACKGROUND OF THE INVENTION

### Field of the Invention

The present inventive concept relates to a power-saving method and an electronic device for performing power consumption management by controlling the system-activating event.

### Description of the Related Art

Users often utilize their electronic devices to run various software applications. Some software applications will use a network service to synchronize the server with the electronic device. For example, the synchronization between the server and the electronic device includes client/server handshake, content query, and information update. However, sometimes unnecessary synchronization triggered by software applications affects suspend state or standby state of the electronic device. Thus keeps the electronic device from entering suspend state or standby state and consumes more power. The power of the battery of the electronic device will drop quickly due to unnecessary synchronization. Therefore, a power-saving method and an electronic device for performing power consumption management are needed.

### BRIEF SUMMARY OF THE INVENTION

The invention discloses a power-saving method for performing power consumption management on an electronic device. The power-saving method includes determining whether a software application executed on the electronic device relates to a network service or not; and disabling at least one system-activating event provided by the software application for the electronic device when the software application relates to the network service and when the network service is unavailable to the electronic device.

In some embodiments, when the software application relates to the network service, the network-related software application is recorded. Whether the software application relates to the network service or not is determined by the properties of the software application. In addition, a determination is made as to whether the software application relates to the network service or not according to the behavior exhibited by the software application, and register of the alarm trigger is allowed by the electronic device when the network service is available to the electronic device. Furthermore, the alarm trigger is enabled when the network service is available to the electronic device. In other embodiments, the system-activating event is a wake lock to keep the electronic device in an active state, and the wake lock is enabled when the network service is available to the electronic device.

In one aspect of the disclosure, a power-saving method for performing power consumption management on an electronic device is provided. The power-saving method includes recording at least one software application which relates to a network service by the electronic device; determining whether an executing software application matches the recorded software application or not; and disabling at least one system-activating event provided by the executing software application for the electronic device when the executing software application matches the recorded software application and when the network service is unavailable to the electronic device. The system-activating event is an alarm trigger to switch the electronic device from a standby state to an active state and/or a wake lock to keep the electronic device in an active state.

In another aspect of the disclosure, an electronic device for performing power consumption management is provided. The electronic device includes a framework, a connector and a memory. The framework is utilized to determine whether a software application executed on the electronic device relates to a network service or not. The connector is utilized to detect whether a network service is available to the electronic device or not. The framework disables at least one system-activating event provided by the software application for the electronic device when the software application relates to the network service and when the network service is unavailable to the electronic device. The memory is utilized to record the software application which relates to a network service. Specifically, the framework determines whether the software application relates to the network service or not according to the properties of the software application or the behavior exhibited by the software application. Afterward, the framework enables the system-activating event when the network service is available to the electronic device.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating an electronic device according to an embodiment of the invention;

FIG. 2 is another schematic diagram illustrating an electronic device according to an embodiment of the invention;

FIG. 3 is another flowchart illustrating a power-saving method for performing power consumption management with the wake lock according to an embodiment of the invention;

FIG. 4 is another flowchart illustrating a power-saving method for performing power consumption management with the alarm trigger according to an embodiment of the invention;

FIG. 5 is another flowchart illustrating a power-saving method for performing power consumption management on an electronic device according to an embodiment of the invention;

FIG. 6A is a schematic illustrating the current of the electronic device without applying the power-saving method according to an embodiment of the invention;

FIG. 6B is a schematic illustrating the current of the electronic device which applies the power-saving method according to an embodiment of the invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF THE INVENTION

The following description is of the best-contemplated mode of carrying out the invention. This description is made for the purpose of illustrating the general principles of the invention and should not be taken in a limiting sense. Certain terms and figures are used throughout the description and following claims to refer to particular components. As one skilled in the art will appreciate, manufacturers may refer to a component by different names. This document does not intend to distinguish between components that differ in name but not function. The terms “component”, “system” and “device” used in the present invention could be the entity relating to the computer which is hardware, software, or a combination of hardware and software. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

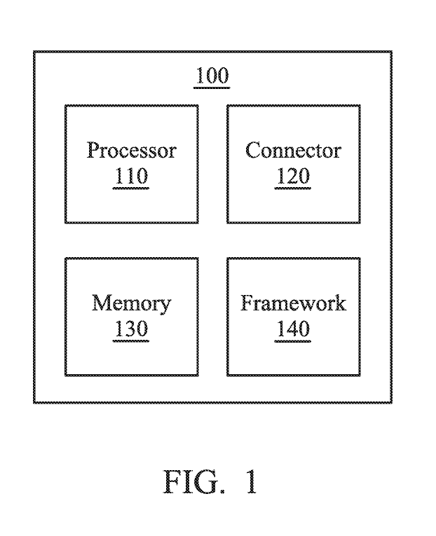

FIG. 1 is a schematic diagram illustrating an electronic device 100 according to an embodiment of the invention. The electronic device 100 could be a portable electronic device, such as a cell phone, a tablet computer, a laptop computer or a PDA, or it could be stationary electronic apparatus such as a television set, a desktop computer, or a server. The electronic device 100 could provide wireless network service and network connection. As shown in FIG. 1, the electronic device 100 includes a processor 110, a connector 120, a memory 130 and a framework 140. The processor 110 could include a digital signal processor (DSP), a microcontroller (MCU), a central-processing unit (CPU) or a plurality of parallel processors of a parallel processing environment to implement the operating system (OS), firmware, driver and/or other applications of the electronic device 100. The connector 120 is utilized to perform network service between different electronic devices 100 based on various protocols. The protocol of network service could constitute GSM, GPRS, EDGE, UMTS, W-CDMA, CDMA2000, TD-CDMA, Bluetooth, NFC, WiFi, WiMAX, LTE, LTE-A or TD-LTE. Furthermore. The connector 120 could be utilized to detect whether a network service is available to the electronic device or not.

In addition, the memory 130 includes one or more of the following: a register, a buffer, a random access memory (RAM), a read-only memory (ROM), a flash memory, a hard disk, a soft disk, a magnetic memory, a compact disc (CD) and a digital video disk (DVD). The framework 140 is utilized for the electronic device 100 to execute various types of software applications. Specifically, the framework could be embedded within the processor 110 and operated by the processor 110.

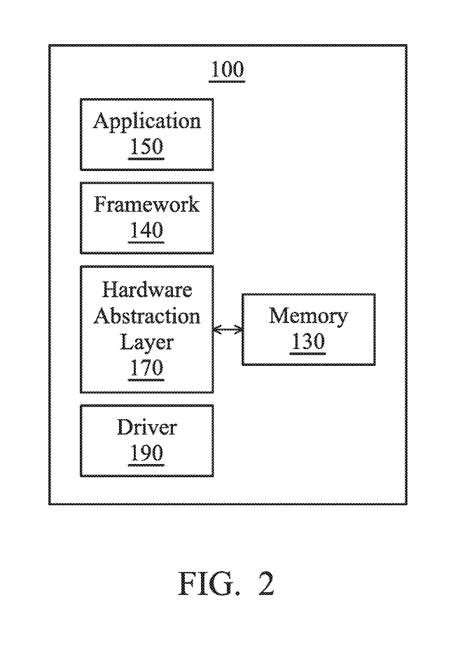

FIG. 2 is another schematic diagram illustrating an electronic device 100 according to an embodiment of the invention. The electronic device 100 includes the application 150, the framework 140, the hardware abstraction layer (HAL) 170, the memory 130, and the driver 190. The application 150 could be a software application which includes one or more of a social network application, a gaming application, a home application, a dialer application, an SMS/MMS application, an IM application, a browser application, a camera application, an alarm application, a calculator application, a contacts application, a voice dial application, an email application, a calendar application, a media player application, a photo album application or a clock application. Some kinds of applications could be related to the network service, such as a social network application, a gaming application, or a browser application. The framework 160 could include one or more of an activity manager framework, a window manager framework, a content provider framework, a view system framework, a notification manager framework, a package manager framework, a telephone manager framework, a resource manager framework or a location manager framework.

The driver 190 is utilized to drive its corresponding hardware so that the corresponding hardware or components could be utilized by the electronic device 100. Since the electronic device 100 could include various kinds of hardware, there could also be various corresponding drivers. In addition, the hardware abstraction layer (HAL) 170 is utilized to link with one of the drivers and function as the connection between the software and hardware of the electronic device 100. Furthermore, libraries (not shown) could also be arranged between the framework 160 and the hardware abstraction layer 170.

In some embodiments, the connector 120 is utilized to detect whether a network service is available to the electronic device or not. The framework 140 is utilized to determine whether a software application executed on the electronic device 100 relates to a network service or not. Afterward, the memory 130 is utilized to record whether the software application relates to a network service based on the determination made by the framework 140. When the software application relates to the network service and the network service is unavailable to the electronic device 100, the framework 140 disables at least one system-activating event provided by the operating system for the electronic device 100. Specifically, the system-activating event could be an alarm trigger to switch the electronic device 100 from a standby state to an active state. In addition, the system-activating event could also be a wake lock to keep the electronic device 100 in an active state for a period of time.

Because synchronization of the electronic device 100 with the server is mainly required by the network service related software application, a determination is made as to whether the software application relates to the network service or not. In this disclosure, the network service related software application will become the target for power-saving and power-management. In addition, a detection, and a subsequent determination is made as to whether the network service of the surrounding environment is available to the electronic device 100 or not. If the network service is not available to the electronic device 100, synchronization will not be able to perform between the electronic device 100 and the server. In the absence of network service, attempting and trying to synchronize will be in vain and also be a waste of power. By utilizing the power-saving method of the present invention, unnecessary and fruitless synchronization may be avoided by disabling the system-activating event of synchronization when the software application relates to the network service and the network service is unavailable to the electronic device 100.

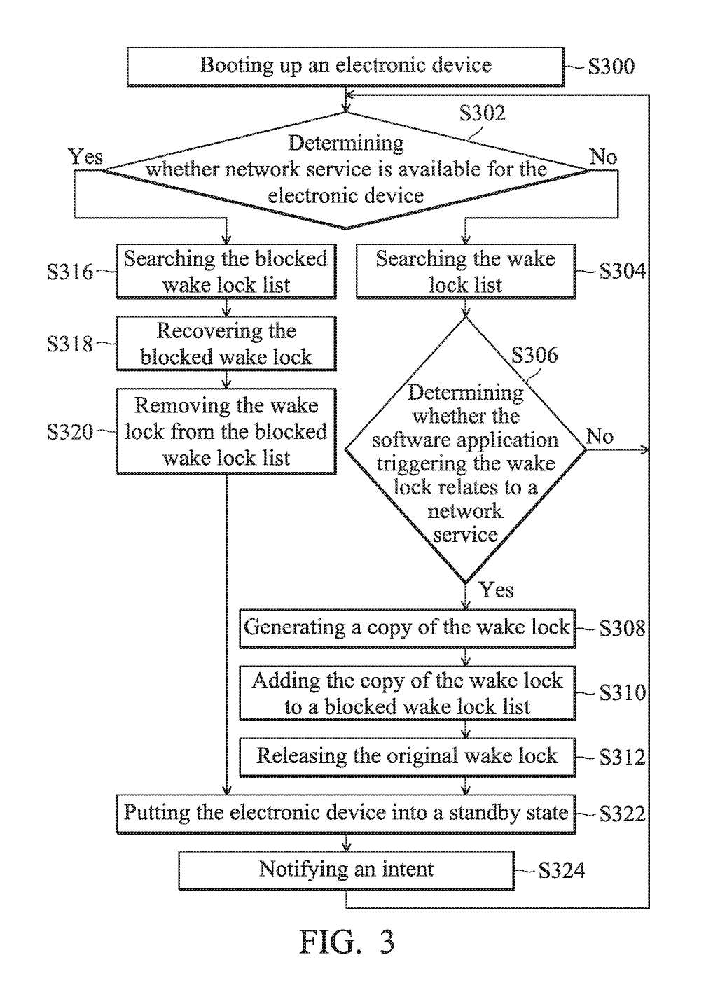

FIG. 3 is a flowchart illustrating a power-saving method for performing power consumption management with the wake lock according to an embodiment of the invention. In step S300, the electronic device 100 boots up. In step S302, a determination is made as to whether the network service is available to the electronic device 100 or not. If the network service is available to the electronic device 100, step S316 will be executed. If the network service is not available to the electronic device 100, step S304 will be executed. In step S304, the framework 140 searches a wake lock list. More specifically, the searching operation in step S304 is configured to obtain default wake lock for comparing with the software application which is initiated randomly as illustrated in step S306. Accordingly, whether a software application triggered wake lock relates to a network service or not could be determined.

In step S306, the framework 140 determines whether each software application triggered wake lock relates to a network service or not. If the software application triggered wake lock does not relate to a network service, the flow goes back to step S302 again. If the software application triggered wake lock relates to a network service, step S308 will be performed so that a copy of the network related, software application triggered wake lock is generated. The copy is the list of the wake locks which are network related and triggered by the software application. In step S310, the copy of the network related, software application triggered wake lock is added to a blocked wake lock list. Afterward, as shown in step S312, the original wake lock is released which means the electronic device perform wake locks except those on the blocked wake lock list. In this embodiment, when the network service is not available, the network-related wake lock will be blocked so that the electronic device 100 will not be activated due to the network-related wake lock event. It should be noted that the software application still works since it is not terminated, but the network related wake lock of the software application is temporarily blocked.

Afterwards, when the electronic device 100 enters into a standby state, as in step S322, an intent is notified for indicating whether there is network service or not, as in step S324. Then the flow goes back to step S302, again determine whether network service is available to the electronic device 100 or not. If the network service is available to the electronic device 100, step S316 is executed to search the blocked wake lock list and find out the blocked wake locks. In step S318, these blocked wake lock are recovered and further removed from the blocked wake lock list in step S320. Afterwards, the flow goes to step S322 when the electronic device 100 enters into a standby state. Therefore, when the network service is available to the electronic device 100, the blocked wake lock will be recovered to execute the wake lock for the electronic device 100. Regarding the power-saving method of the present invention, the wake lock will be temporarily blocked when the network service is unavailable and recovered when the network service is available. The unnecessary power consumption which results from performing a wake lock without any network service could be avoided by the power-saving method of the present invention.

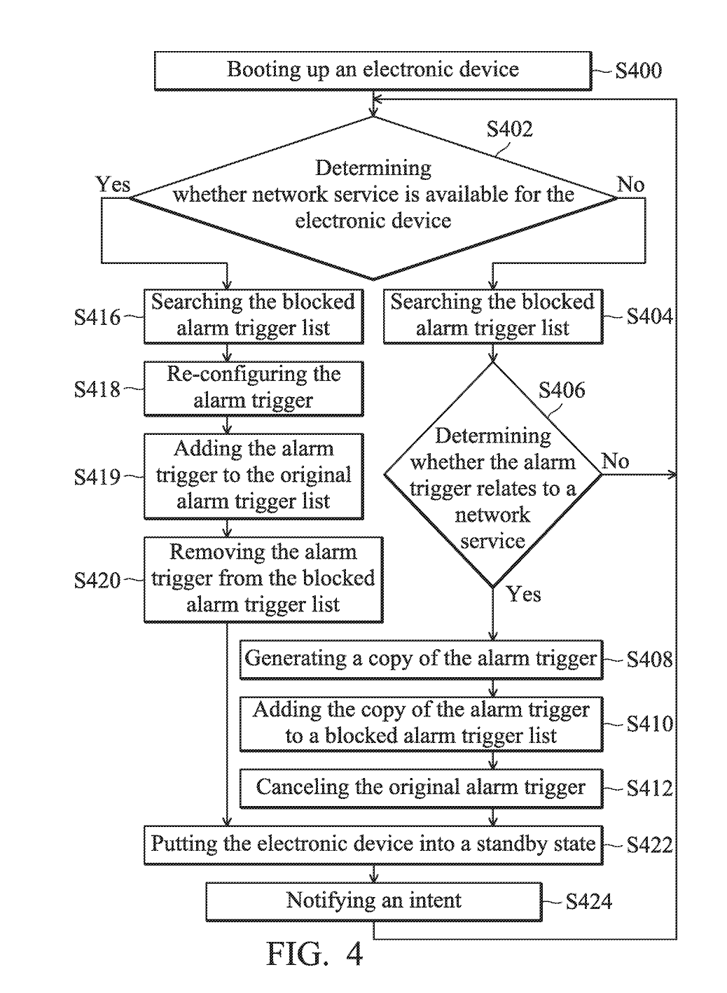

FIG. 4 is another flowchart illustrating a power-saving method for performing power consumption management with the alarm trigger according to an embodiment of the invention. In step S400, the electronic device 100 is booted up. In step S402, a determination is made as to whether the network service is available to the electronic device 100 or not. If the network service is available to the electronic device 100, step S416 will be executed. If the network service is not available to the electronic device 100, step S404 will be executed. In step S404, the framework 140 searches a blocked alarm trigger list.

In step S406, the framework 140 determines whether the alarm trigger relates to a network service or not. If the alarm trigger does not relate to a network service, flow goes back to S402. If the alarm trigger relates to a network service, step S408 will be performed so that a copy of the alarm trigger is generated. The copy is the list of the alarm triggers which are network related and triggered by the software application. In step S410, the copy of the alarm trigger is added to the blocked alarm trigger list. Afterwards, the original alarm trigger is canceled, as shown in step S412. In the flowchart shown above, when the original alarm trigger is determined to be unrelated to a network, the network-related original alarm trigger will be blocked so that the electronic device 100 will not be activated due to the original alarm trigger event. It should be noted that the software application still works since it is not terminated, but the original alarm trigger of the software application is temporarily blocked.

Afterwards, when the electronic device 100 enters into a standby state, as shown in step S422, an intent is notified for indicating whether there is network service or not, as shown in step S424. Afterwards, step S402 is executed again to determine whether network service is available to the electronic device 100 or not. If the network service is available to the electronic device 100, step S416 is executed so that the blocked alarm trigger list is searched. Furthermore, the alarm trigger is reconfigured as shown in step S418. More specifically, the alarm trigger is reconfigured to activate the electronic device 100 when the network service is available. In addition, the alarm trigger is added to the original alarm trigger list as shown in step S419, and the alarm trigger is removed from the blocked alarm trigger list as shown in step S420. Afterwards, step S422 is executed to put the electronic device 100 into a standby state.

Therefore, when the network service is available to the electronic device 100, the blocked alarm trigger list will be recovered to execute the alarm trigger for the electronic device 100. Regarding the power-saving method of the present invention, the alarm trigger will be temporarily blocked when the network service is unavailable and recovered when the network service is available. The unnecessary power consumption which results from performing a wake lock without any network service could be avoided by the power-saving method of the present invention.

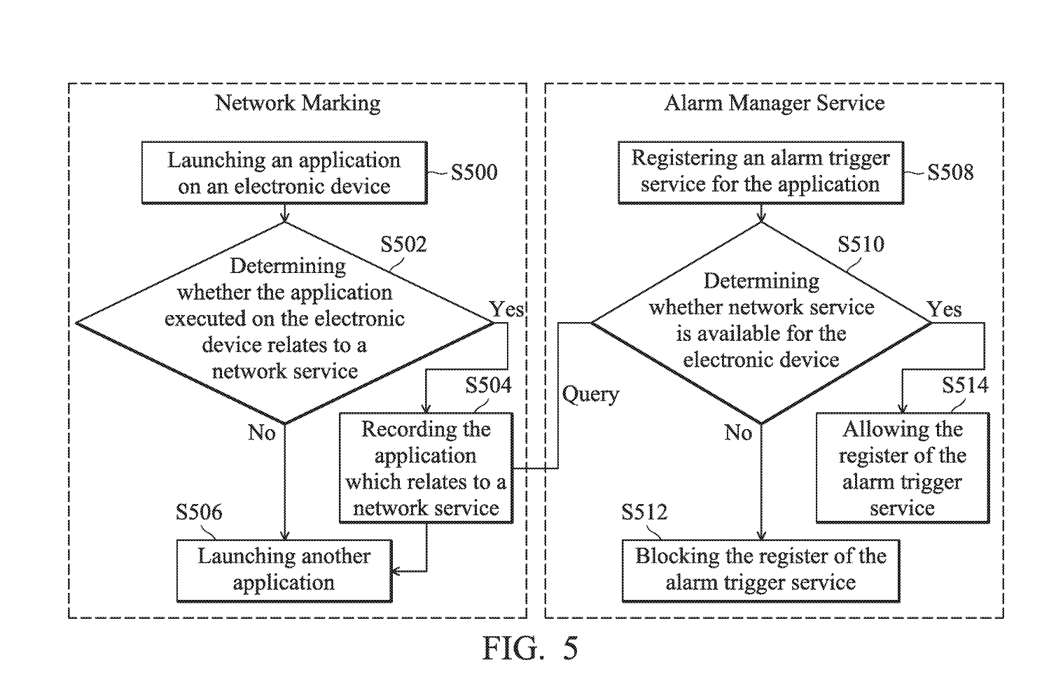

FIG. 5 is another flowchart illustrating a power-saving method for performing power consumption management with an alarm trigger on the electronic device 100 according to an embodiment of the invention. In this embodiment, step S500 to step S506 are for network relation marking, and step S508 to step S514 are the alarm manager service which could be executed by the processor 110. In step S500, a software application is launched on an electronic device 100. In step S502, a determination is made as to whether the software application executed on the electronic device relates to a network service or not. If the software application executed on the electronic device does not relate to the network service, step S506 will be executed. If the software application executed on the electronic device relates to the network service, step S504 will be executed to record the network-related software application. In addition, step S506 will be executed to launch another software application.

In addition, an alarm trigger service for the application is registered, as shown in step S508. Afterwards, in step S510, a determination is made as to whether a network service is available to the electronic device 100 or not. In S510, framework of the electronic device 100 catch the network service information from the records from S504. If the network service is not available to the electronic device 100, step S512 will be executed to block the register of the alarm trigger service. In other words, the alarm trigger will not be operated for the electronic device 100. If the network service is available to the electronic device 100, step S514 will be executed to allow the registration of the alarm trigger service. In other words, the alarm trigger will be executed to activate the electronic device 100.

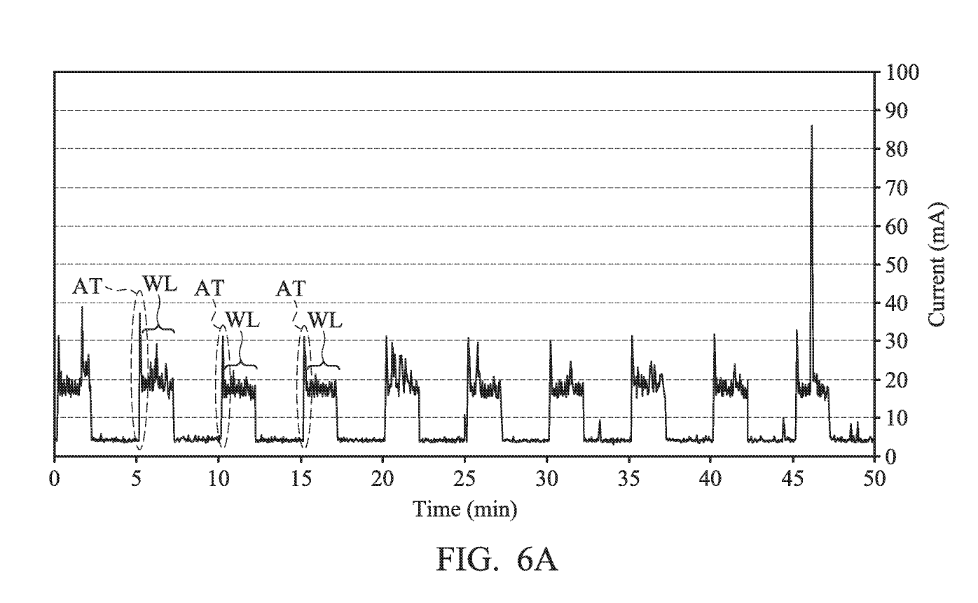

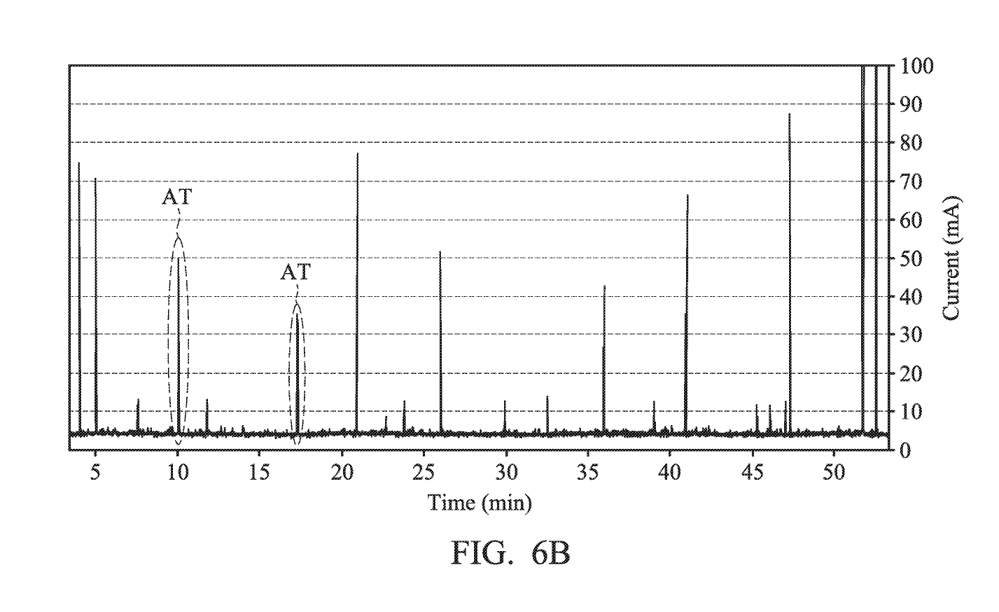

FIG. 6A is a schematic illustrating the current of the electronic device 100 without applying the power-saving method according to an embodiment of the invention, and FIG. 6B is a schematic illustrating the current of the electronic device 100 which applies the power-saving method according to an embodiment of the invention. Regarding FIG. 6A, there is an alarm trigger AT and a wake lock WL every five minutes. Therefore, the current is often high-level, and power is wasted. Regarding FIG. 6B, by utilizing the power-saving method of the present invention for controlling the system-activating events according to the network-service and their properties, both the alarm trigger AT and the wake lock WL are decreased. The current in FIG. 6B is almost maintained at a low level, less than ten mA. Therefore, it consumes less power than the embodiment of FIG. 6A.

The present invention provides a power-saving method which temporarily disables or postpones the system-activating event when the software application relates to the network service and the network service is unavailable to the electronic device 100. When the surrounding environment lacks network service, unnecessary and fruitless synchronization will result in high power consumption and decrease the battery capacity of the electronic device 100. By utilizing the power-saving method of the present invention, the unnecessary and fruitless synchronization can be avoided, to improve the power consumption of the electronic device 100. In addition, the system-activating event can be automatically recovered and executed when the network service is available. Software and users should be transparent during this period because unavailable network have no impact to software for data transfer. Therefore, the power-saving method of the present invention operates unseen by users and may be applied to adjust various different kinds of software applications.

Although embodiments of the present disclosure and their advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power-saving method for performing power consumption management on an electronic device, comprising:
determining whether a software application triggered system-activating event executed on the electronic device relates to a network service or not; and
disabling the software application triggered system-activating event when the software application triggered system-activating event relates to the network service and when the network service is unavailable to the electronic device.

2. The power-saving method as claimed in claim 1, further comprising: when the software application triggered system-activating event relates to the network service, recording the network service related software application triggered system-activating event.

3. The power-saving method as claimed in claim 1, wherein whether the software application triggered system-activating event relates to the network service or not is determined by properties of the software application.

4. The power-saving method as claimed in claim 1, wherein whether the software application triggered system-activating event relates to the network service or not is determined by behavior exhibited by the software application triggered system-activating event.

5. The power-saving method as claimed in claim 1, wherein the system-activating event is an alarm trigger to switch the electronic device from a standby state to an active state.

6. The power-saving method as claimed in claim 5, further comprising: allowing register of the alarm trigger by the electronic device when the network service is available to the electronic device.

7. The power-saving method as claimed in claim 5, further comprising: enabling the alarm trigger when the network service is available to the electronic device.

8. The power-saving method as claimed in claim 1, wherein the software application triggered system-activating event is a wake lock to keep the electronic device in an active state.

9. The power-saving method as claimed in claim 8, further comprising: enabling the wake lock when the network service is available to the electronic device.

10. A power-saving method for performing power consumption management on an electronic device, comprising:
recording at least one software application which relates to a network service by the electronic device;
determining whether an executing software application matches the recorded software application or not; and
disabling at least one system-activating event provided by the executing software application for the electronic device when the executing software application matches the recorded software application and when the network service is unavailable to the electronic device.

11. The power-saving method as claimed in claim 10, further comprising:
determining whether the software application relates to the network service or not according to the properties of the software application.

12. The power-saving method as claimed in claim 10, further comprising:
determining whether the software application relates to the network service or not according to behavior exhibited by the software application.

13. The power-saving method as claimed in claim 10, further comprising:
enabling the system-activating event when the network service is available to the electronic device.

14. The power-saving method as claimed in claim 10, wherein the system-activating event is an alarm trigger to switch the electronic device from a standby state to an active state.

15. The power-saving method as claimed in claim 10, wherein the system-activating event is a wake lock to keep the electronic device in an active state.

16. An electronic device for performing power consumption management, comprising:
a framework, utilized to determine whether a software application executed on the electronic device relates to a network service or not; and
a connector, utilized to detect whether a network service is available to the electronic device or not, wherein the framework disables at least one system-activating event provided by the software application for the electronic device when the software application relates to the network service and when the network service is unavailable to the electronic device.

17. The electronic device as claimed in claim 16, further comprising:
a memory, utilized to record the software application which relates to a network service.

18. The electronic device as claimed in claim 16, wherein the framework determines whether the software application relates to the network service or not according to the properties of the software application or behavior exhibited by the software application.

19. The electronic device as claimed in claim 16, wherein the framework enables the system-activating event when the network service is available to the electronic device.

20. The electronic device as claimed in claim 16, wherein the system-activating event is an alarm trigger to switch the electronic device from a standby state to an active state.
